(19) United States
(12) Patent Application Publication
(10) Pub. No.: US 2002/0141776 A1
(43) Pub. Date: Oct. 3, 2002

(54) Image processing apparatus

(76) Inventors: Tatsuji Hirakawa, Aichi-Ken (JP); Jiro Goto, Aichi-Ken (JP); Katsuhisa Toyama, Toyokawa-Shi (JP); Kaoru Tada, Aichi-Ken (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/103,720

(22) Filed: Mar. 25, 2002

(30) Foreign Application Priority Data
Mar. 30, 2001 (JP) 2001-102617

(51) Int. Cl. G03G 15/00

(52) U.S. Cl. 399/81

(57) ABSTRACT

On a display device of an operation panel of a copier, the user can input an operation condition of a job, and various statuses of the copier can be displayed. When an operation by the user on the operation panel is not performed for a predetermined period of time, the operation panel shifts to an energy saving mode and the display device is turned off. In a case where the copier is connected to a network, when a print job is received from a client terminal, it is determined whether the operation panel is in the energy saving mode or not. When the operation panel is not in the energy saving mode, it is shifted to the energy saving mode. When an error such as a paper jam occurs during printing, the energy saving mode of the operation panel is canceled, and an error message is displayed on the display device. When an error is removed, printing is resumed, and the operation panel is shifted to the energy saving mode.

The present application claims priority to Japanese Patent Application No. 2001-102617 filed Mar. 30, 2001, the entire content of which is hereby incorporated by reference.

### BACKGROUND OF THE INVENTION

1. Field of the Invention

The present invention relates to the power saving control of an image processing apparatus, and more particularly, to the power saving control of a display device of an operation panel of an image processing apparatus.

2. Description of the Related Art

In recent years, environmental problems and the like have been increasing social demands for energy saving in OA apparatuses, particularly, OA apparatuses mainly for image processing such as copiers, printers, facsimiles and scanners (hereinafter, collectively referred to as image processing apparatuses). Particularly, as the setting of copy modes and the like of copiers and communication functions of facsimiles and the like have become complicated, the liquid crystal display panel of the operation panel has increased in size, and some are as large as B5-sized. Therefore, the power consumed thereby cannot be ignored, and an effective power saving control in the display portion including the liquid crystal display panel is desired.

However, in the conventional image processing apparatuses, only when the operation panel is not operated for a predetermined period of time, the backlight or the like of the liquid crystal display portion of the operation panel is turned off to perform power saving control, which cannot be said to sufficiently meet the demands for energy saving.

Particularly, recently, network-ready image processing apparatuses used with client terminals such as personal computers connected through a local-area network (LAN) have been rapidly spreading, and no effective power saving control has been considered for the network-ready image processing apparatuses.

### SUMMARY OF THE INVENTION

A principal object of the present invention is to provide an image processing apparatus capable of effectively performing the power saving control of the display device.

To attain this and other objects, according to an aspect of the present invention, an image processing apparatus comprises: a reception device accepting a job transmitted from an external terminal; a display device displaying a status of the apparatus; and a controller causing the display device to be in an energy saving mode during processing of the job accepted by the reception device.

By the controller alternatively executing a first energy saving mode to perform power saving of only the display device and a second energy saving mode to perform power saving of the entire apparatus including the display device, when a job is accepted by the reception device during execution of the second energy saving mode, the power saving control can be performed with the energy saving mode changed from the second mode to the first mode.

Moreover, according to another aspect of the present invention, an image processing apparatus comprises: a reception device accepting a job; a display device displaying a status of the apparatus; determination means for determining whether an execution condition of the job accepted by the reception device is the same as a condition of initial setting or not; and control means for causing the display device to be in an energy saving mode during execution of the job when the determination means determines that the execution condition of the accepted job is the same as the condition of the initial setting.

Further, detection means for detecting that an operation trouble occurs in the apparatus may be provided so that the power saving control is canceled when an operation trouble is detected by the detection means.

Moreover, detection means for detecting that the user operates an operation input portion may be provided so that the power saving control is canceled when an input is detected by the detection means.

Further, display request acceptance means for accepting a display request from an external terminal may be provided so that the power saving control is canceled when the display request acceptance means accepts a display request.

The invention itself, together with further objects and attendant advantages, will best be understood by reference to the following detailed description taken in conjunction with the accompanying drawings.

### BRIEF DESCRIPTION OF THE DRAWINGS

FIG. 1 is a schematic view showing the structure of an image processing system in embodiments of the present invention;

FIG. 2 is a schematic cross-sectional view showing the structure of a copier in the image processing system;

FIG. 3 is an external view showing the structure of an operation panel of the copier;

FIG. 4 is a block diagram of a controller in the copier;

FIG. 5 is a flowchart showing a power saving control operation in a first embodiment of the present invention;

FIG. 6 is a flowchart showing the control operation of a processing to cancel an energy saving mode of an image reader in the first embodiment of the present invention;

FIG. 7 is a flowchart showing the control operation of a processing to accept a panel display request in the first embodiment of the present invention;

FIG. 8 is a view showing the condition of the operation panel in the energy saving mode condition while the copier is operating;

FIG. 9 is a flowchart showing a power saving control operation in a second embodiment of the present invention;

FIG. 10 is a flowchart of a power saving control operation in a third embodiment of the present invention; and

FIGS. 11a and 11b are views showing lighting conditions of the operation panel in a case where the operation panel is provided with a sub panel in the copier.

### DETAILED DESCRIPTION OF THE PREFERRED EMBODIMENTS

Hereinafter, embodiments of the present invention will be described with reference to the drawings.

### FIRST EMBODIMENT

A digital copier capable of accepting a print job from another terminal through a network will be described as a first embodiment of the image processing apparatus of the present invention.

### (1) Structure of the Image Processing System and the Copier

First, the image processing system in which the copiers of embodiments of the present invention are used will be briefly described.

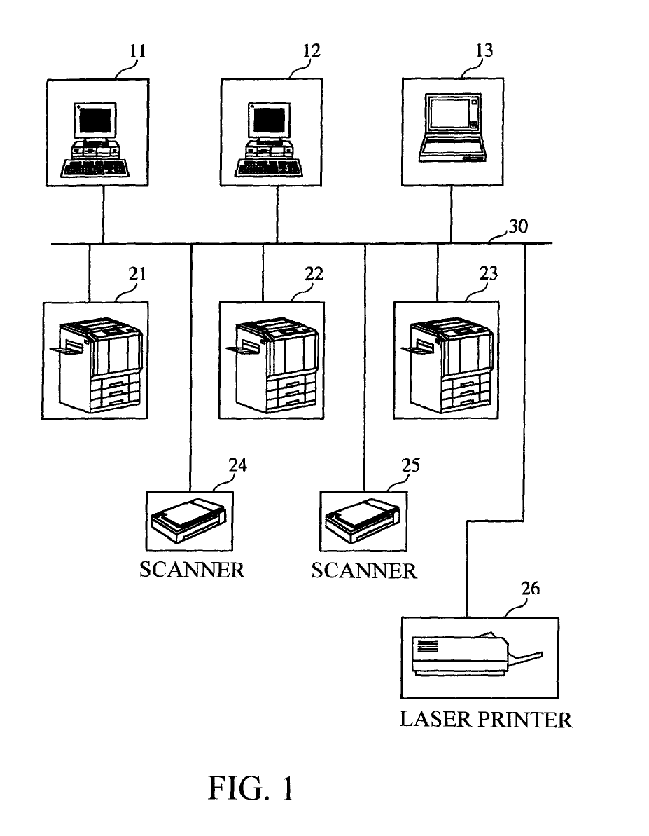

FIG. 1 is a schematic view showing the general structure of the image processing system. As shown in the figure, in the image processing system, personal computers (hereinafter, referred to as “client terminals”) 11 to 13, copiers 21 to 23, scanners 24 and 25, and a laser printer 26 are connected through a LAN 30.

In each of the client terminals 11 to 13, a network-ready operating system (OS), a printer driver, an application software program for producing documents and the like are preinstalled. When a document produced by use of the application software program is printed, not only the image data (or the text data) but also a print request signal, information on print conditions such as the paper size and the number of copies (hereinafter, referred to as “header information”) and the like are transmitted to a desired one of the copiers 21 to 23 through the LAN 30.

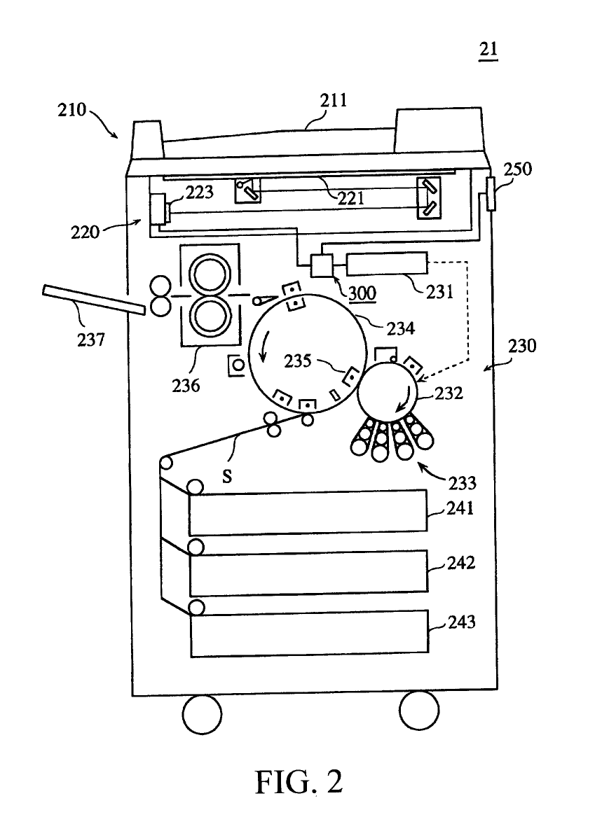

FIG. 2 is a schematic cross-sectional view showing the general structure of the copier 21. As shown in the figure, the copier 21 comprises an automatic document feeder 210, an image reader (IR) 220 reading the document image, and a printer 230 reproducing the read image by printing it on a recording sheet.

The automatic document feeder 210 feeds the document placed on a document tray 211 sheet by sheet to a predetermined reading position on a document glass 221.

The IR 220 reads the document image on the document glass 221 with a CCD image sensor 223 and converts it to an RGB electric signal. The electric signal is converted to a CMYK digital signal by a controller 300, and undergoes known corrections so that image data of each color component is produced.

The printer 230 having the structure of an intermediate transfer method comprises a print head 231, a photoconductor drum 232, and paper feed cassettes 241 to 243 for separately holding sheets by size. The print head 231 drives an incorporated laser diode (not shown) based on the image data, and causes the laser beam from the laser diode to expose and scan the photoconductor drum 232. Consequently, an electrostatic latent image is formed on the surface of the photoconductor drum 232. The latent image is developed with the toner supplied from a developer unit 233.

A recording sheet S fed from any of the paper feed cassettes 241 to 243 is wound on the surface of an intermediate transfer drum 234, and the toner image formed on the photoconductor drum 232 is transferred onto the recording sheet S by the electrostatic force of a transfer charger 235. In the case of a full-color image, the intermediate transfer drum 234 is rotated four times so that the toner images of C, M, Y and K are successively transferred. Then, the recording sheet S is separated from the intermediate transfer drum 234, and sent to a fixer 236. The toner image on the recording sheet is fixed by heat pressurization at the fixer 236, and ejected onto a paper output tray 237.

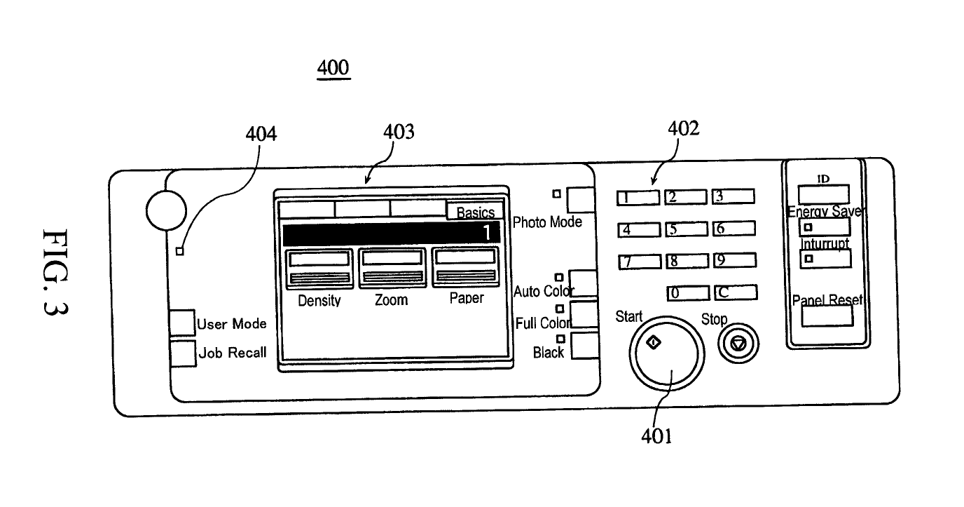

The controller 300 is connected to the LAN 30 through a connector 250 provided on a side surface of the IR 220. An operation panel 400 as shown in FIG. 3 is provided in an easy-to-operate position in an upper part of the front surface of the IR 220.

The operation panel 400 has a start key 401 for starting printing, a numeric keypad 402 for setting the number of copies and the like, a display 403, and an indicator 404 for notifying that copying is underway. The display 403 is formed by laminating a transparent touch panel on the surface of a liquid crystal display panel. On the display 403, various messages such as a message indicating whether printing is possible or not and a message warning that no sheet is left in any of the paper feed cassettes 241 to 243, the number of copies set by the user and the like can be shown to the user, and selection of a paper feed cassette to be used from among the paper feed cassettes 241 to 243 and setting of job execution conditions such as the copy mode can be performed according to the menu screen.

The copiers 22 and 23 are similar in structure to the copier 21.

### (2) Structure of the Controller 300

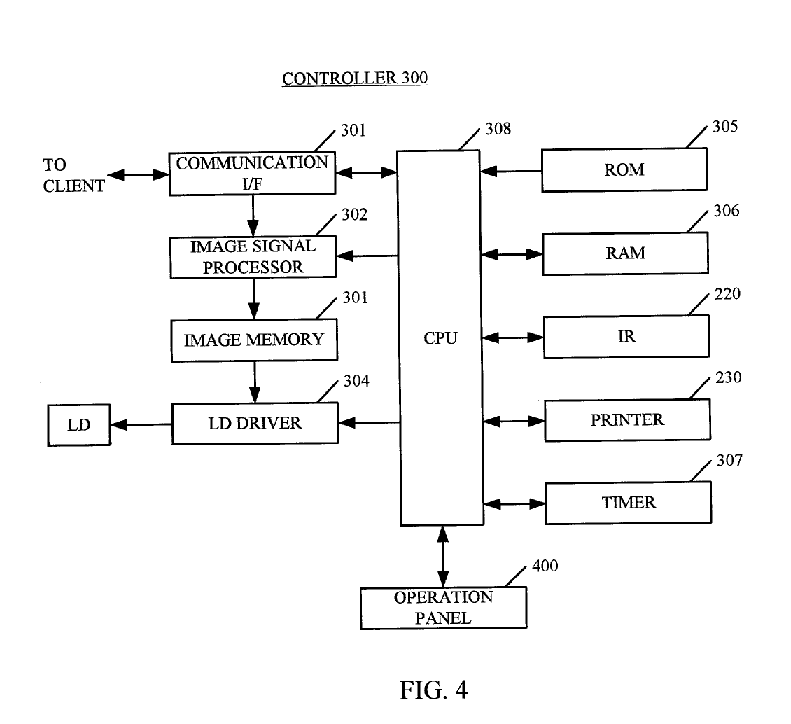

FIG. 4 is a block diagram showing the structure of the controller 300 in the copier 21.

As shown in the figure, the controller 300 comprises a communication I/F 301, an image signal processor 302, an image memory 303, an LD driver 304, a ROM 305, a RAM 306, a timer 307 and a CPU 308.

The communication I/F 301 receives data transmitted from the client terminals 11 to 13 through the LAN 30, and when the received data is a print job, separates it into image data and header information. The header information is transmitted to the CPU 308. The image data is transmitted to the image signal processor 302, and after undergoing various image processings such as edge enhancement, the image data is stored in the image memory 303. The header information includes a print request signal, a signal representative of the end of transmission, and information representative of job execution conditions such as the sheet size and the number of copies. When the data received by the communication I/F 301 is a signal requesting reading of the document set on the IR 220 (this signal is also a copy print request signal) or execution conditions of the job to be executed by the IR 220 (for example, the magnification, the sheet size, the number of copies), these are transmitted to the CPU 308. Message information and the like issued from the CPU 308 to the users operating the client terminals 11 to 13 are transmitted to the client terminals 11 to 13 through the communication I/F 301.

Receiving an instruction from the CPU 308, the LD driver 304 reads out the processed image data from the image memory 303, and drives the laser diode LD based on the image data.

In the ROM 305, a control program for performing the above-described image formation and a power saving control described later is stored. In the RAM 306, to execute the control program, various control variables and flags are temporarily stored.

The timer 307 counts the time for which the operation panel 400 is not operated (including the time for which the operation of the copier is stopped because of a trouble such as a paper jam). When the time exceeds a predetermined time and when a request for a print job (local job) comes from any of the client terminals 11 to 13 through the LAN 30, the CPU 308 automatically performs a function (energy saving mode) to perform the power saving control of the operation panel 400. Details will be described later.

Receiving the print request signal, the document reading request signal and the job execution condition information through the communication I/F 301, and the document reading request signal received from the operation panel 400, the CPU 308 reads out a necessary program from the ROM 305, and controls the IR 220, the printer 230 and the LD driver 304 so that smooth printing is performed. Moreover, the CPU 308 accepts various key inputs from the operation panel 400, displays the condition of the copier and a warning message such that no recording sheet S is left in any of the paper feed cassettes 241 to 243 on the display 403 of the operation panel 400, and performs a necessary power saving control.

### (3) Power Saving Control in the Copier

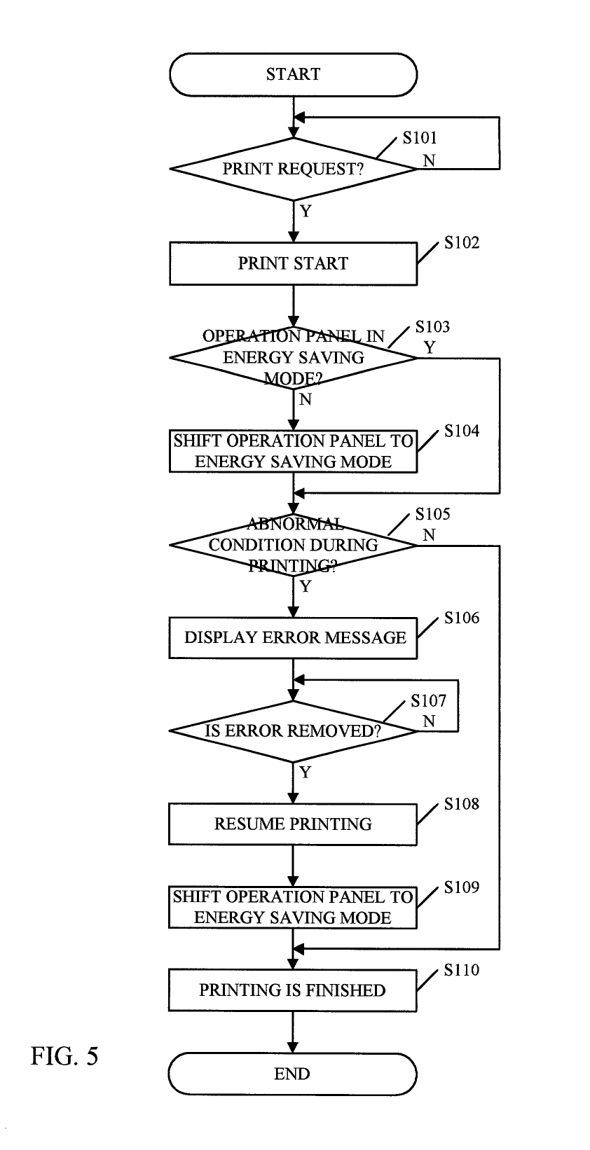

In the present embodiment, a control operation in the copier 21 performed when a print request is received from one of the client terminals 11 to 13 (for example, the client terminal 11) through the LAN 30 will be described with reference to the flowchart of FIG. 5.

First, at step S101 of FIG. 5, it is determined whether a print request is received from the client terminal 11 or not. This determination can be made based on whether a print request signal is received by the CPU 308 through the communication I/F 301 or not. When a print request is received (Y of step S101), printing is started, and it is determined whether the operation panel 400 of the copier is in an energy saving mode or not (steps S102 and S103). As mentioned above, the operation panel 400 automatically shifts to the energy saving mode when a predetermined time has elapsed with the copier 21 not operating. In that case, a flag representative of this is set in the RAM 306, and whether the energy saving mode is currently being executed or not is determined by referring to the condition of the flag.

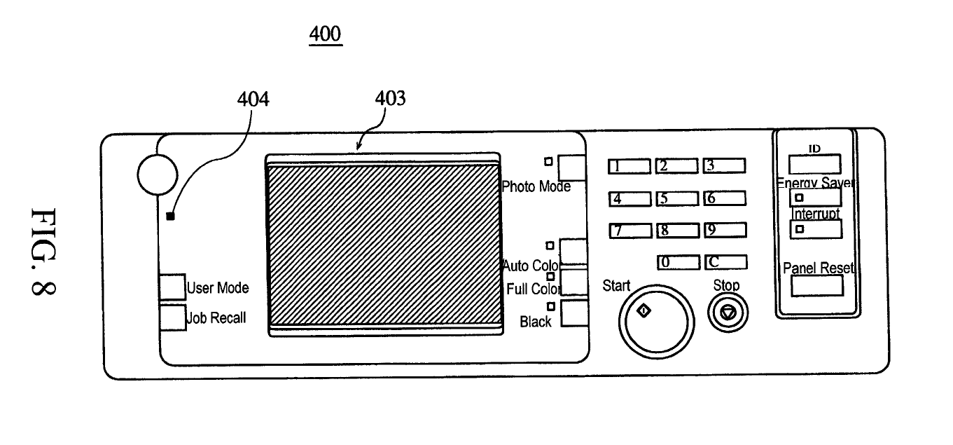

When the operation panel 400 of the copier 21 is not in the energy saving mode, the operation panel 400 shifts to the energy saving mode (N of step S103, step S104). In the energy saving mode, the screen of the display 403 of the operation panel 400 of the copier 21 is blanked by turning off the backlight of the display 403. Therefore, when the operation panel 400 of the copier 21 is shifted to the energy saving mode, the operation panel 400 is shifted from a condition in which the display 403 is lit as shown in FIG. 3 to a condition in which the screen of the display 403 is blanked and only the indicator 404 notifying that copying is underway is lit as shown in FIG. 8.

Then, it is determined whether or not printing cannot be continued because of the occurrence of an abnormal condition (error) such as a paper jam during printing (step S105). The occurrence of a paper jam can be easily detected by a paper jam detection by a known jam sensor. Examples of other errors include running out of recording sheets S (paper emptiness) in any of the paper feed cassettes 241 to 243 and running out of toner. These can be detected by known detection methods.

When an error occurs, since it is necessary to quickly notify the user of the occurrence of the error so that the user can remove the error, the energy saving mode is canceled, an error message is displayed on the display 403 (Y of step S105, step S106), and the process waits until the error is removed (step S107). When the error is removed, printing is resumed, and the operation panel 400 shifts to the energy saving mode (Y of step S107, steps S108 and S109). When printing is finished (step S110), the control is ended.

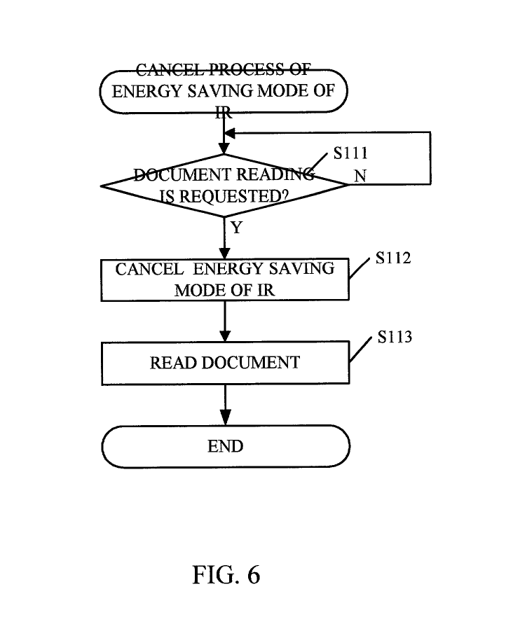

FIG. 6 is a flowchart when the document is read by use of the IR 220 of the copier 21. The processing can break in the operation of the flowchart of FIG. 5 so as to be performed in parallel therewith. However, when an error occurs during printing at step S105 of FIG. 5, even if the error occurs in a part other than the IR 220, it is desired to inhibit the break-in until the error is removed.

At step S111 of the figure, it is determined whether a document reading request is issued or not. When the user sets a document on the document feeder 210 and depresses the start key 401 of the operation panel 400, the depression is detected by the CPU 308, so that it is determined that a document reading request is issued.

It is determined that a document reading request is issued also when the user sets a document on the document feeder 210 and transmits a reading request from the client terminal 11. In this case, the determination is made based on whether or not a request for reading of the client document is received by the CPU 308 through the communication I/F 301.

When a document reading request is issued (Y of step S111), the energy saving mode of the IR 220 is canceled, and document reading is performed (steps S112 and S113). During this operation, the operation panel 400 is in the energy saving mode unless an error or the like occurs. Although not specifically shown in the flowchart, when a predetermined time has elapsed from the document reading, the IR 220 automatically shifts to the energy saving mode.

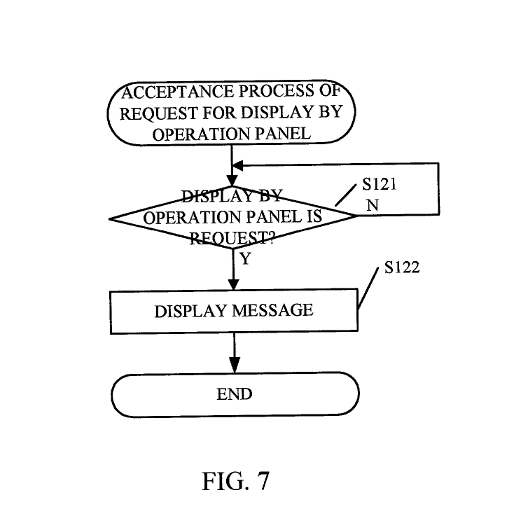

FIG. 7 is a flowchart showing an acceptance processing performed by the copier 21 when a request for message display by the operation panel is issued from a client terminal through the LAN 30. This processing breaks in the operation of the flowchart of FIG. 5 when the display request is issued.

First, at step S121, it is determined whether a request for display by the operation panel 400 is issued from a client terminal or not. This determination can be made based on whether or not a signal requesting display by the operation panel 400 is received by the CPU 308 through the communication I/F 301. When a request for display by the operation panel 400 is received (Y of step S121), the energy saving mode is canceled, and a message indicating the print status or the like is displayed on the display 403 (step S122).

This is very convenient, particularly, when the client terminal is a portable terminal having a small-size display, because the detailed copy mode and error status can be checked by canceling the energy saving mode of the operation panel 400 of the copier 21. Since it is unnecessary to issue a display request from a client terminal when the display 403 is already lit, this break-in is applied when the operation panel 400 is in the energy saving mode.

As described above, according to the present embodiment, in addition to the conventionally performed automatic power saving control in which the operation panel 400 shifts to the energy saving mode by not being operated for a predetermined period of time, the operation panel 400 positively shifts to the energy saving mode also when it is determined to be unnecessary to provide a display on the operation panel 400, so that an excellent power saving effect is obtained.

That is, in a case where a print request is issued from a client terminal, since the user of the client terminal issuing the print request is frequently away from the copier 21 and it is unnecessary for the user to see the operation panel 400 except when it is necessary to check the print status, it is not very necessary for the display 403 to be lit. In a case where a document reading request is issued from a client terminal, since it is unnecessary for the user to see the display on the operation panel 400 except when the detailed copy mode is checked or when a setting change is made, it is not very necessary for the display 403 to be lit also in this case. While when an error occurs, the energy saving mode is canceled and a message is displayed on the display 403 to prompt the user to remove the error, when the error is removed, the operation panel 400 shifts to the energy saving mode because it is no longer necessary for the display 403 to be lit. Although not shown in the flowchart of FIG. 5, when the operation panel 400 is not operated and the error is not removed before a predetermined period of time elapses from the provision of the error message on the display 403, the conventional automatic power saving control works to shift the operation panel 400 to the energy saving mode. The energy saving mode is canceled also when a display request is issued from a client terminal, and in this case, the operation panel 400 also shifts to the energy saving mode when a predetermined period of time has elapsed.

By performing the control in this manner, the energy saving mode is executed except when a display by the operation panel 400 is necessary, so that an extremely high power saving effect is obtained.

### SECOND EMBODIMENT

Next, a second embodiment of the image processing apparatus of the present invention will be described. The second embodiment is different from the first embodiment in the contents of the power saving control. The structure of the copier is the same as that of the first embodiment and a description thereof is therefore omitted.

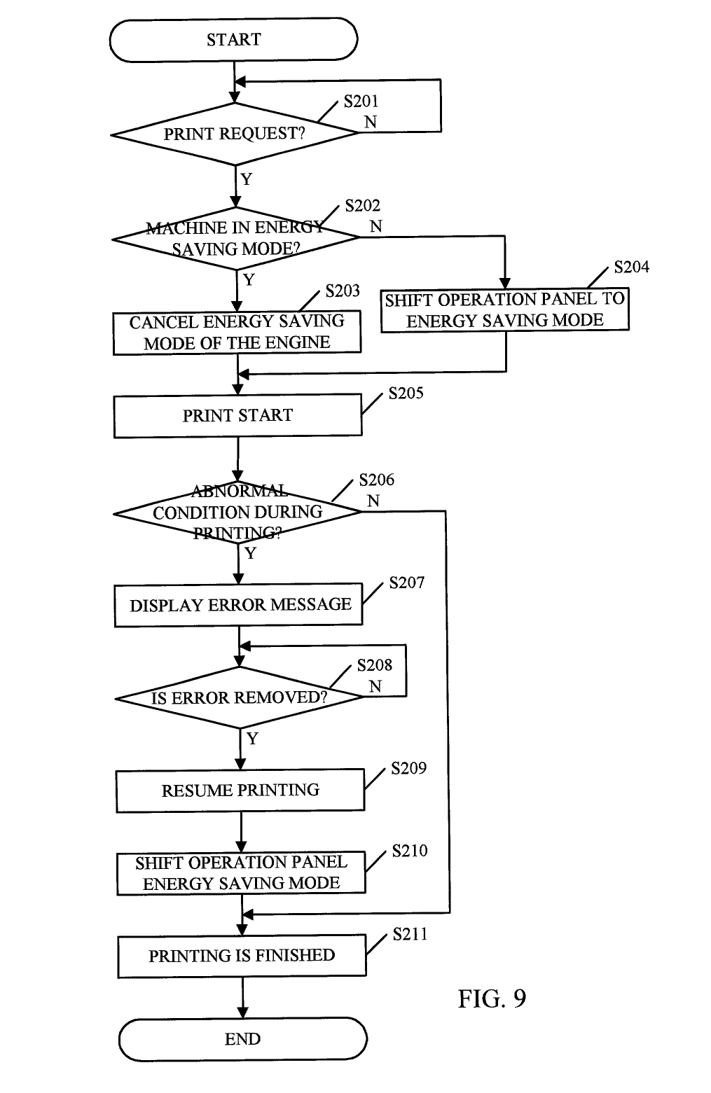

FIG. 9 is a flowchart for explaining mainly the power saving operation in the present embodiment.

First, at step S201, it is determined whether a print request is received from any of the client terminals 11 to 13 or not. This determination can be easily made based on whether a print request signal is received by the CPU 308 from the communication I/F 301 or not. When a print request is received (Y of step S201), it is determined whether the machine, that is, the entire copier 21 is in the energy saving mode or not (step S202).

In the second embodiment, the power saving control is performed in the following two steps: an energy saving mode of the entire copier 21 including the operation panel 400; and an energy saving mode of only the operation panel 400. In the former energy saving mode of the entire copier 21, power is supplied only to the controller 300 and hardly any power is supplied to the operation panel 400 and the heater of the fixer 236. This mode is executed when a predetermined period of time has elapsed from the execution of the energy saving mode of only the operation panel 400.

In the present embodiment, when the energy saving modes are executed, a flag representative of the execution is set in the ROM 306. At step S202, the CPU 308 determines whether the entire copier 21 is in the energy saving mode or not by checking the condition of the flag.

When the entire copier 21 is in the energy saving mode (Y of step S202), only the operation panel 400 is held in the energy saving mode, and only the parts necessary for printing such as the printer 230 are released from the power saving condition (step S203). When the entire copier 21 is not in the energy saving mode (N of step S202), only the operation panel 400 shifts to the energy saving mode (step S204). Then,printing is started (step S205).

At the next step S206 and succeeding steps, a control similar to that at step S105 and succeeding steps of FIG. 5 is performed. That is, it is determined whether an error such as a paper jam occurs during printing or not (step S206). When an error occurs, the energy saving mode is canceled and an error message is displayed on the display 403 (Y of step S206, step S207). When the error is removed by the user, printing is resumed, and the operation panel 400 shifts to the energy saving mode (Y of step S208, steps S209 and S210). When printing is finished, the control operation is ended (step S211).

In the present embodiment, the operations shown in FIGS. 6 and 7 also break in the control operation of FIG. 9 so as to be performed in parallel therewith.

As described above, according to the present embodiment, in a case where a print request is received from a client terminal when the entire copier 21 is in the energy saving mode, the operation panel 400 is held in the energy saving mode and only the functional parts necessary for printing are released from the power saving condition to thereby prevent power from being wastefully consumed, so that an excellent power saving effect is obtained.

### THIRD EMBODIMENT

Next, a third embodiment of the image processing apparatus of the present invention will be described.

The present embodiment is characterized by the power saving control performed when the user performs copying in front of the copier 21 by operating the operation panel 400. The structure of the copier 21 is the same as that of the first embodiment.

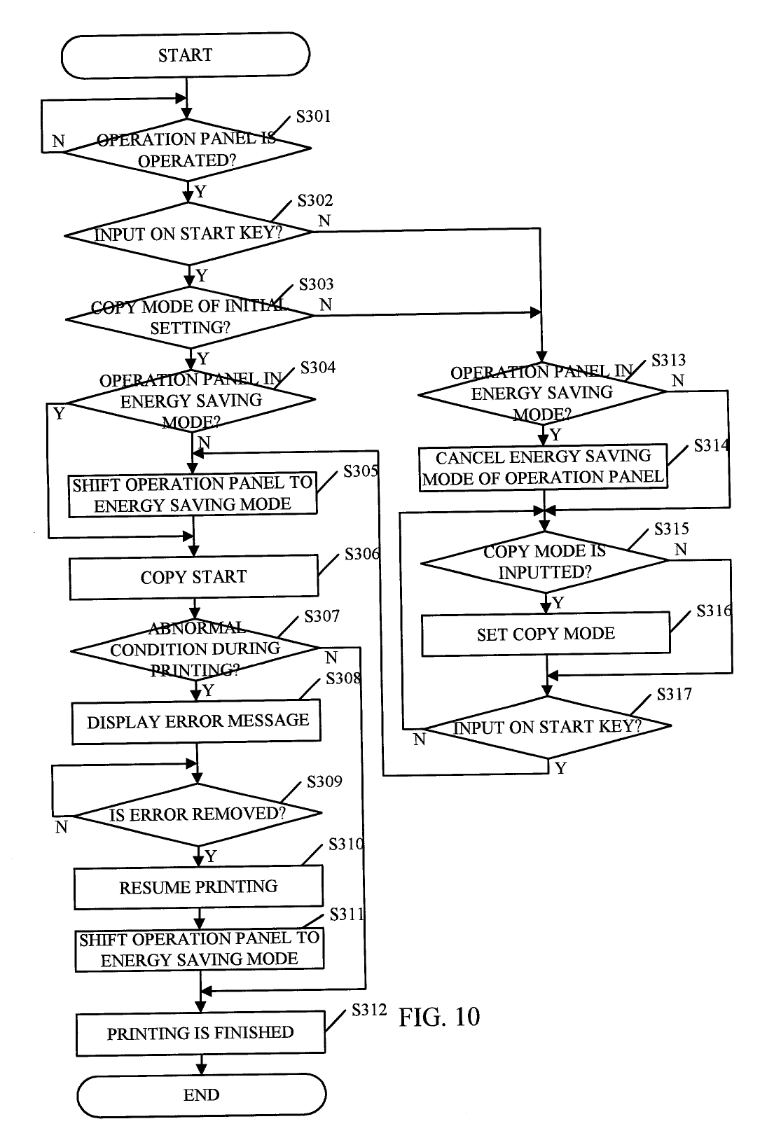

FIG. 10 is a flowchart for explaining the power saving operation in the present embodiment.

First, at step S301, it is determined whether the operation panel 400 is operated or not. This determination can be made by the CPU 308 detecting the user's input operation on the operation panel 400. Then, it is determined whether the operation on the operation panel 400 is an input on the start key 401 or not (Y of step S301, step S302) . When the first operation on the operation panel 400 is an input on the start key 401, it is considered that the user intends to perform copying in the copy mode of the initial setting (for example, single-sided copying of A4 size, one copy per sheet). Therefore, it is determined whether the current copy mode is the copy mode of the initial setting or not (Y of step S302, step S303).

Normally, when the user sets a copy mode different from that of the initial setting, the content of the setting is temporarily stored in the RAM 306, and is reset to the default mode when a predetermined period of time has elapsed. For this reason, even though the user depresses the start key 401 first with the intention of performing copying in the mode of the initial setting, when the copy mode set in the RAM 306 at the execution of the previous copy job has not been reset yet, a copy mode different from the default mode is executed. Therefore, it is necessary to check whether the current copy mode set in the RAM 306 is the copy mode of the initial setting or not like at step S303.

When the current copy mode is the copy mode of the initial setting (Y of step S303), since it is no longer necessary to perform an operation on the operation panel 400, it is checked whether the operation panel 400 is currently in the energy saving mode or not. When the operation panel 400 is not in the energy saving mode, it is shifted to the energy saving mode (N of step S304, step S305), and copying is started (step S306).

When the panel operation is not an input operation on the start key 401 at step S302 and when, although the panel operation is an input operation on the start key 401, it is determined at step S303 that the current copy mode is not the copy mode of the initial setting, to change the copy mode to the one desired by the user, it is determined whether the operation panel 400 is currently in the energy saving mode or not (step S313), the energy saving mode is canceled when the operation panel 400 is in the energy saving mode (step S314), and the process waits for an input of a copy mode (step S315). When an input by the user is accepted by the operation panel 400, the content of the input is set in the RAM 306, and then, the process waits for an input on the start key 401 (step S317).

When an input on the start key 401 is performed at step S317, since it is no longer necessary to perform an operation on the operation panel 400, the process moves to step S305, where the operation panel 400 is shifted to the energy saving mode. Then, copying is started (step S306).

The succeeding steps S307 to S311 are a processing to cancel the energy saving mode to display a message when an error occurs in the copier 21, and a description thereof is omitted because the contents thereof are completely the same as those of steps S106 to S109 of FIG. 5 and steps S206 to S210 of FIG. 9.

As described above, according to the present embodiment, whether the user intends to perform a copy job in the initial setting or not is determined based on the condition of the input by the user on the operation panel 400, and when the current copy mode is the copy mode of the initial setting, the operation panel 400 is shifted to the energy saving mode and copying is started. Since the display 403 is lit only when it is necessary to do so such as when the copy mode is set and when an error message is displayed, a power saving effect in the copier is obtained. Further, since the most frequently used copy mode is set as the copy mode of the initial setting, the operation panel 400 can be held in the energy saving mode for a longer period of time, so that power consumption is reduced.

While in the present embodiment, a case is described where the user sets a document on the document feeder 210 and operates the operation panel 400, a similar control can be performed when a print job or a copy job is requested from a client terminal. In this case, the determination at step S301 is “whether a print request is issued from a client terminal or not”, and the determination at step S302 is “whether a copy mode requested by the client terminal is the copy mode of the initial setting or not.” The power saving control is performed with the contents other than that the same as those of FIG. 10.

### MODIFICATIONS

While the present invention has been described based on the embodiments, the contents of the present invention are not limited to the embodiments but, for example, the following modifications can be made:

(1) While in the above-described embodiments, one main panel is provided as the display 403 of the operation panel 400 of the copier 21 and the operation panel 400 is not lit in the energy saving mode so that no message can be displayed, the present invention is not limited thereto. A sub panel consuming less power than such a main panel may be provided so that only the sub panel is lit in the energy saving mode.

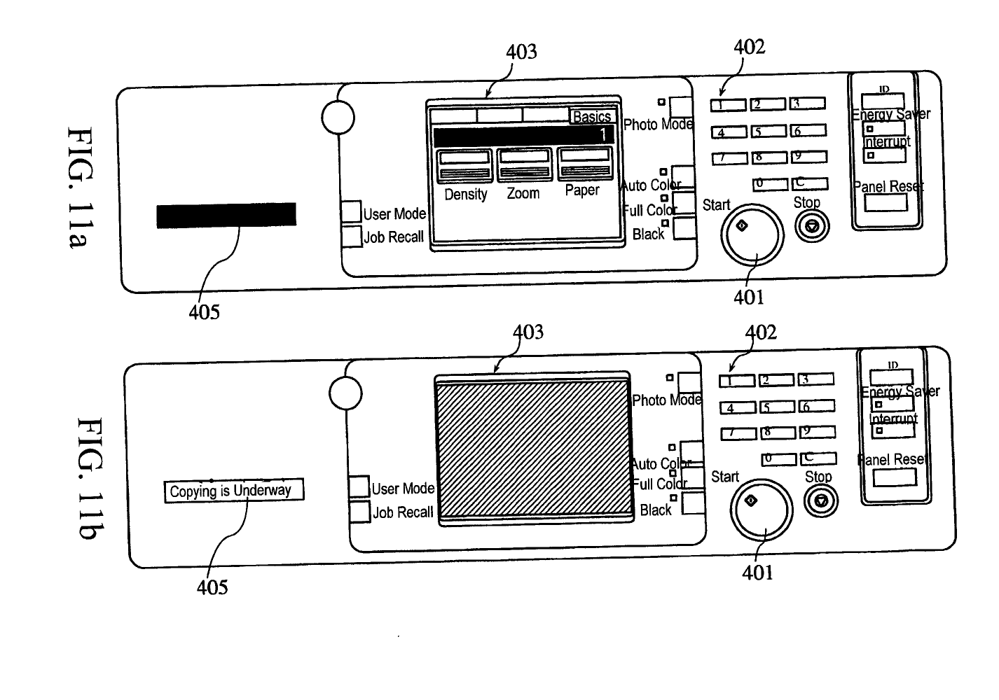

FIGS. 11a and 11b are external views of an operation panel provided with a sub panel. In the figures, the same reference numbers as those of FIG. 3 designate the same parts. As shown in the figures, the operation panel comprises the start key 401 for starting printing, the numeric keypad 402 for setting the number of copies and the like, a main panel 403, and a sub panel 405.

The sub panel 405 is an indicator notifying that copying is underway, and is structured so as to consume less power than the main panel 403. When the main panel 403 is lit as shown in FIG. 11a, the sub panel 405 is not lit. The energy saving mode condition of the operation panel in the copier during operation is such that the sub panel 405 notifying that copying is underway is lit as shown in FIG. 11 (b) and the backlight of the main panel 403 is off. Consequently, the power consumption by the operation panel in the copier during operation can be suppressed, so that a power saving effect is obtained while a necessary message is delivered to the user.

(2) While the power saving control of copiers is shown in the above-described embodiments, the present invention is applicable to image processing apparatuses having a display such as scanners and laser printers.

(3) Since there are cases where another user is waiting for the previous print job to be finished in front of the copier, it is very convenient if the display 403 is lit when the printing is finished and a message notifying the finish of the printing is displayed.

(4) While an example in which the communication I/F 301 accepts a job from the LAN 30 is described in the above-described embodiments, a job may be accepted from an external terminal with a form other than a LAN (for example, short-distance radio communication such as Bluetooth™ or IrDA)

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. An image processing apparatus comprising:
a reception device which accepts a job transmitted from an external terminal;
a display device which displays a status of the apparatus; and
a controller which causes said display device to be in an energy saving mode during processing of the job accepted by said reception device.

2. An image processing apparatus as claimed in claim 1, wherein said controller alternatively executes a first energy saving mode to perform power saving of only said display device and a second energy saving mode to perform power saving of the entire apparatus including said display device.

3. An image processing apparatus as claimed in claim 2, wherein said controller changes the energy saving mode from the second energy saving mode to the first energy saving mode when a job is accepted by the reception device during execution of the second energy saving mode.

4. An image processing apparatus as claimed in claim 1, further comprising:
trouble detection means for detecting that an operation trouble occurs in the apparatus; and
cancel means for canceling the energy saving mode when the operation trouble is detected by said trouble detection means during execution of the energy saving mode of said display device.

5. An image processing apparatus as claimed in claim 1, wherein the job includes a document reading job.

6. An image processing apparatus as claimed in claim 1, wherein the job includes a print job.

7. An image processing apparatus as claimed in claim 1, further comprising:
input device which inputs a signal by an operation by a user;
input detection means for detecting the input by said input device; and
cancel means for canceling the energy saving mode when the input is detected by said input detection means during execution of the energy saving mode of said display device.

8. An image processing apparatus as claimed in claim 1, further comprising:
display request acceptance means for accepting a display request from an external terminal; and
cancel means for canceling the energy saving mode when said display request acceptance means accepts a display request.

9. An image processing apparatus as claimed in claim 1, wherein said controller blanks the screen of said display device.

10. An image processing apparatus as claimed in claim 9, wherein said controller turns off the backlight of said display device.

11. An image processing apparatus comprises:
a reception device which accepts a job;
a display device which displays a status of the apparatus;
determination means for determining whether an execution condition of the job accepted by said reception device is the same as a condition of initial setting or not; and
controller which causes said display device to be in an energy saving mode during execution of the job when said determination means determines that the execution condition of the accepted job is the same as the condition of the initial setting.

12. An image processing apparatus as claimed in claim 11, further comprising:
trouble detection means for detecting that an operation trouble occurs in the apparatus; and
cancel means for canceling the energy saving mode when the operation trouble is detected by said trouble detection means during execution of the energy saving mode of said display device.

13. An image processing apparatus as claimed in claim 11, wherein the job includes a document reading job.

14. An image processing apparatus as claimed in claim 11, wherein the job includes a print job.

15. An image processing apparatus as claimed in claim 11, further comprising:
input device which inputs a signal by an operation by a user;
input detection means for detecting the input by said input device; and
cancel means for canceling the energy saving mode when the input is detected by said input detection means during execution of the energy saving m ode of said display device.

16. An image processing apparatus as claimed in claim 11, wherein
said reception device accepts the job sent from an external terminal.

17. An image processing apparatus as claimed in claim 1, wherein said controller blanks the screen of said display device.

18. An image processing apparatus as claimed in claim 17, wherein said controller turns off the backlight of said display device.
